(19) United States
(12) Patent Application Publication
(10) Pub. No.: US 2023/0279196 A1
(43) Pub. Date: Sep. 7, 2023

(54) ULTRAVIOLET STABILIZED POLYMERIC COMPOSITIONS

(71) Applicant: Dow Global Technologies LLC, Midland, MI (US)

(72) Inventors: Wenke Miao, Shanghai (CN); Chao He, Shanghai (CN); Xianmin Xu, Shanghai (CN); Yuming Lai, Midland, MI (US); Jing Yu, Malvern, PA (US); Mohamed Esseghir, Lawrenceville, NJ (US); Xiaoxiong Miao, Shanghai (CN)

(21) Appl. No.: 18/008,200

(22) PCT Filed: Sep. 7, 2020
(86) PCT No.: PCT/CN2020/113770

§ 371 Date: Dec. 5, 2022

(51) Int. Cl. C08K 3/22; C08K 5/3435; C09D 123/06

(52) U.S. Cl. CPC C08K 3/22; C08K 5/3435; C09D 123/06; C08K 2003/2296; C08K 2003/222; C08K 2201/019

(57) ABSTRACT

A polymeric composition includes 90 wt % to 99 wt % of an ethylene-based polymer based on a total weight of the polymeric composition; 0.1 wt % to 1 wt % of a hindered amine light stabilizer based on the total weight of the polymeric composition; and 0.1 wt % to 5.0 wt % of at least one of MgO, Mg (OH)₂, ZnO and Zn (OH)₂ based on the total weight of the polymeric composition.

### BACKGROUND

### Field of the Invention

The present disclosure generally relates polymeric compositions and more specifically to ultraviolet stabilized polymeric compositions.

### INTRODUCTION

Polymeric jacketing materials are used as an outermost layer of protection for a variety of power and telecommunication cables. The jacketing helps to protect against physical damage the cable may endure during installation and/or use. Jacketing may be colored to help visually distinguish one cable from another. Jacketing installed on cables used outdoors undergo weathering as a result of ultraviolet light and other environmental factors.

Free radicals and acids are generated within the polymeric jacketing during exposure to ultraviolet light (“UV”) and environmental conditions. The free radicals oxidize polymers of the jacketing leading to decreased mechanical properties of the jacketing with increased UV exposure. Oxidation of the polymers forms acids within the jacketing. Various UV weathering standards exist for cables that require a cable to retain a predetermined amount of its tensile strength and tensile elongation at break after a certain accelerated UV testing time period.

A conventional approach to mitigate the effect of free radicals in outdoor or high UV light exposure environments is to include both carbon black and hindered amine light stabilizers (“HALS”). Carbon black, while effective in absorbing ultraviolet light and preventing free radical generation, has a strong effect on the ability to impart a desired color to the jacketing. In addition to carbon black, HALS are utilized in the polymeric jacketing to neutralize free radicals that are generated. HALS are effective in neutralizing free radicals, but are deactivated by acids present in the environment of the polymer jacketing. As such, attempts at creating colorable cables through the exclusive use of HALS to prevent degradation of jacketing results in accelerated mechanical property degradation due to the greater production of free radicals and the deactivation of the HALS via the acids.

Attempts at creating a colorable jacketing that is UV resistant have been attempted. For example, World Intellectual Property Organization publication number 2014/177153A1 discloses the use of a calcium carbonate containing material within the jacketing of cables to prevent the deactivation of HALS by environmental acids. While the calcium carbonate neutralizes the environmental acids, mechanical properties of the polymeric jacketing are expected to fade over time.

In view of the foregoing, it would be unexpected to discover a polymeric composition useful as a jacketing that is both colorable and can be used to make a cable that passes UV weathering standards.

### SUMMARY OF THE DISCLOSURE

The present disclosure provides a polymeric composition useful as a jacketing that is both colorable can be used to make a cable that passes UV weathering standards. Surprisingly, embodiments of the invention provide a polymeric composition useful as a jacketing that is both colorable and can be used to make a cable surpasses the requirements UV weathering standards.

The present invention is a result of discovering that while metal carbonates are effective at neutralizing strong acids from a cable's environment, metal oxides are more effective at neutralizing acids generated within the polymeric jacketing due to polymer oxidation. Metal oxides, in the presence of water, form a metal hydroxide compound. The metal hydroxide compound exhibits a proton affinity greater than metal carbonates. As a result, the metal hydroxide exhibits a greater efficacy in neutralizing acids generated from polymer oxidation than metal carbonates. The use of metal oxides thereby maintains the activity of the HALS longer than metal carbonates and the polymeric jacketing of the cable exhibits a greater retention of mechanical properties after accelerated UV exposure. The greater efficacy of the metal oxides and hydroxides allows for the polymeric composition to be free of carbon black and therefore colorable.

The polymeric composition of the present disclosure is useful in wire and cable applications.

According to a first feature of the present disclosure, a polymeric composition comprises 90 wt % to 99 wt % of an ethylene-based polymer based on a total weight of the polymeric composition; 0.1 wt % to 1 wt % of a hindered amine light stabilizer based on the total weight of the polymeric composition; and 0.1 wt % to 5.0 wt % of at least one of MgO, Mg(OH)₂, ZnO and Zn(OH)₂ based on the total weight of the polymeric composition.

According to a second feature of the present disclosure, the polymeric composition is free of carbon black.

According to a third feature of the present disclosure, the polymeric composition further comprises a colorant.

According to a fourth feature of the present disclosure, the ethylene-based polymer comprises a low-density polyethylene having a density of 0.917 g/cc to 0.926 g/cc as measured according to ASTM D792 and a high-density polyethylene having a density of 0.940 g/cc to 0.970 g/cc as measured according to ASTM D792.

According to a fifth feature of the present disclosure, the polymeric composition comprises 80 wt % to 95 wt % high-density polyethylene based on the total weight of the polymeric composition.

According to a sixth feature of the present disclosure, the polymeric composition comprises 5 wt % to 20 wt % of the low-density polyethylene based on the total weight of the polymeric composition.

According to a seventh feature of the present disclosure, the polymeric composition comprises from 0.1 wt % to 3 wt % of at least one of ZnO and Zn(OH)₂.

According to an eighth feature of the present disclosure, the polymeric composition comprises from 1.0 wt % to 2 wt % of at least one of MgO and Mg(OH)₂ based on the total weight of the polymeric composition.

According to a ninth feature of the present disclosure, from 1.4 wt % to 1.8 wt % of the polymeric composition is MgO and Mg(OH)₂ based on the total weight of the polymeric composition.

According to a tenth feature of the present disclosure, a coated conductor comprises a conductor; and the polymeric composition disposed at least partially around the conductor.

### DETAILED DESCRIPTION

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

All ranges include endpoints unless otherwise stated.

Test methods refer to the most recent test method as of the priority date of this document unless a date is indicated with the test method number as a hyphenated two-digit number. References to test methods contain both a reference to the testing society and the test method number. Test method organizations are referenced by one of the following abbreviations: ASTM refers to ASTM International (formerly known as American Society for Testing and Materials); IEC refers to International Electrotechnical Commission; EN refers to European Norm; DIN refers to Deutsches Institut für Normung; and ISO refers to International Organization for Standards.

As used herein, the term weight percent (“wt %”) designates the percentage by weight a component is of a total weight of the polymeric composition unless otherwise specified.

Melt index (I₂) values herein refer to values determined according to ASTM method D1238 at 190 degrees Celsius (° C.) with 2.16 Kilogram (Kg) mass and are provided in units of grams eluted per ten minutes (“g/10 min”).

Density values herein refer to values determined according to ASTM D792 at 23° C. and are provided in units of grams per cubic centimeter (“g/cc”).

As used herein, Chemical Abstract Services registration numbers (“CAS #”) refer to the unique numeric identifier as most recently assigned as of the priority date of this document to a chemical compound by the Chemical Abstracts Service.

### Polymeric Composition

The polymeric composition of the present invention comprises an ethylene-based polymer, a hindered amine light stabilizer, and at least one of MgO, Mg(OH)₂, ZnO and Zn(OH)₂. The polymeric composition may be free of carbon black and as such may be colorable though the optional addition of a colorant.

### Ethylene-Based Polymer

As noted above, one component of the polymeric composition is an ethylene-based polymer. As used herein, “ethylene-based” polymers are polymers in which greater than 50 wt % of the monomers are ethylene though other co-monomers may also be employed. “Polymer” means a macromolecular compound comprising a plurality of monomers of the same or different type which are bonded together, and includes homopolymers and interpolymers. “Interpolymer” means a polymer comprising at least two different monomer types bonded together. Interpolymer includes copolymers (usually employed to refer to polymers prepared from two different monomer types), and polymers prepared from more than two different monomer types (e.g., terpolymers (three different monomer types) and quaterpolymers (four different monomer types)). The ethylene-based polymer can be an ethylene homopolymer. As used herein, “homopolymer” denotes a polymer comprising repeating units derived from a single monomer type, but does not exclude residual amounts of other components used in preparing the homopolymer, such as catalysts, initiators, solvents, and chain transfer agents.

The ethylene-based polymer can have a unimodal or a multimodal molecular weight distribution and can be used alone or in combination with one or more other types of ethylene-based polymers (e.g., a blend of two or more ethylene-based polymers that differ from one another by monomer composition and content, catalytic method of preparation, molecular weight, molecular weight distributions, densities, etc.). If a blend of ethylene-based polymers is employed, the polymers can be blended by any in-reactor or post-reactor process.

The polymeric composition may comprise 90 wt % or greater, or 91 wt % or greater, or 92 wt % or greater, or 93 wt % or greater, or 94 wt % or greater, or 95 wt % or greater, or 96 wt % or greater, or 97 wt % or greater, or 98 wt % or greater, while at the same time, 99 wt % or less, or 98 wt % or less, or 97 wt % or less, or 96 wt % or less, or 95 wt % or less, or 94 wt % or less, or 93 wt % or less, or 92 wt % or less, or 91 wt % or less of the ethylene-based polymer.

The ethylene-based polymer may comprise 50 mol % or greater, 60 mol % or greater, 70 mol % or greater, 80 mol % or greater, 85 mol % or greater, 90 mol % or greater, or 91 mol % or greater, or 92 mol % or greater, or 93 mol % or greater, or 94 mol % or greater, or 95 mol % or greater, or 96 mol % or greater, or 97 mol % or greater, or 97.5 mol % or greater, or 98 mol % or greater, or 99 mol % or greater, while at the same time, 100 mol % or less, 99.5 mol % or less, or 99 mol % or less, or 98 mol % or less, or 97 mol % or less, or 96 mol % or less, or 95 mol % or less, or 94 mol % or less, or 93 mol % or less, or 92 mol % or less, or 91 mol % or less, or 90 mol % or less, or 85 mol % or less, or 80 mol % or less, or 70 mol % or less, or 60 mol % or less of ethylene as measured using Nuclear Magnetic Resonance (NMR) or Fourier-Transform Infrared (FTIR) Spectroscopy. Other units of the ethylene-based polymer may include C₃, or C₄, or C₆, or C₈, or C₁₀, or C₁₂, or C₁₆, or C₁₈, or C₂₀ α-olefins, such as propylene, 1-butene, 1-hexene, 4-methyl-1-pentene, and 1-octene.

The ethylene-based polymer may comprise high-density polyethylene (“HDPE”). HDPE is an ethylene-based polymer having a density of at least 0.940 g/cc, or from at least 0.94 g/cc to 0.97 g/cc. HDPE has a melt index from 0.1 g/10 min. to 25 g/10 min. HDPE can include ethylene and one or more C₃-C₂₀ α-olefin comonomers. The comonomer (s) can be linear or branched. Nonlimiting examples of suitable comonomers include propylene, 1-butene, 1 pentene, 4-methyl-1-pentene, 1-hexene, and 1-octene. HDPE can be prepared with either Ziegler-Natta, chromium-based, constrained geometry or metallocene catalysts in slurry reactors, gas phase reactors or solution reactors. The ethylene/C₃-C₂₀ α-olefin comonomer includes at least 50 wt % ethylene polymerized therein, or at least 70 wt %, or at least 80 wt %, or at least 85 wt %, or at least 90 wt %, or at least 95 wt % ethylene in polymerized form based on the weight of the ethylene-based polymer. In an embodiment, the HDPE is an ethylene/α-olefin copolymer with a density from of 0.9450 g/cc and a melt index of 0.80 g/10 min.

The polymeric composition may comprise 80 wt % or greater, or 81 wt % or greater, or 82 wt % or greater, or 83 wt % or greater, or 84 wt % or greater, or 85 wt % or greater, or 86 wt % or greater, or 87 wt % or greater, or 88 wt % or greater, or 89 wt % or greater, or 90 wt % or greater, or 91 wt % or greater, or 92 wt % or greater, or 93 wt % or greater, or 94 wt % or greater, while at the same time, 95 wt % or less, or 94 wt % or less, or 93 wt % or less, or 92 wt % or less, or 91 wt % or less, or 90 wt % or less, or 89 wt % or less, or 88 wt % or less, or 87 wt % or less, 86 wt % or less, or 85 wt % or less, or 84 wt % or less, or 83 wt % or less, or 82 wt % or less, or 81 wt % or less of HDPE based on the total weight of the polymeric composition.

The ethylene-based polymer may comprise low-density polyethylene (“LDPE”). LDPE resins are commercially available and may be made by any one of a wide variety of processes including, but not limited to, solution, gas or slurry phase Ziegler-Natta, metallocene or constrained geometry catalyzed (CGC), etc. LDPE resins have a density ranging from 0.910 g/cc to 0.926 g/cc. The LDPE can have a melt index of less than 20 g/10 min., or ranging from 0.1 g/10 min. to 10 g/10 min., or from 2 g/10 min. to 8 g/10 min., or from 4 g/10 min. to 8 g/10 min.

The polymeric composition may comprise 5 wt % or greater, or 6 wt % or greater, or 7 wt % or greater, or 8 wt % or greater, or 9 wt % or greater, or 10 wt % or greater, or 11 wt % or greater, or 12 wt % or greater, or 13 wt % or greater, or 14 wt % or greater, or 15 wt % or greater, or 16 wt % or greater, or 17 wt % or greater, or 18 wt % or greater, or 19 wt % or greater, while at the same time, 20 wt % or less, or 19 wt % or less, or 18 wt % or less, or 17 wt % or less, or 16 wt % or less, or 15 wt % or less, or 14 wt % or less, or 13 wt % or less, or 12 wt % or less, or 11 wt % or less, or 10 wt % or less, or 9 wt % or less, or 8 wt % or less, or 7 wt % or less, or 6 wt % or less or less of LDPE based on the total weight of the polymeric composition.

### HALS

The polymeric composition comprises one or more hindered amine light stabilizers. HALS are chemical compounds containing an amine functional group that are used as stabilizers in plastics and polymers. These compounds may be derivatives of tetramethylpiperidine and are primarily used to protect the polymers from the effects of free radical oxidation due to exposure to UV light.

The HALS may include one or more of poly(4-hydroxy-2,2,6,6-tetramethyl-1-piperidineethanol-alt-1,4-butanedioic acid) (CAS #65447-77-0); bis(2,2,6,6-tetramethyl-4-piperidyl) sebacate (CAS #52829-07-9); di-(1,2,2,6,6-pentamethyl-4-piperidyl)-2-butyl-2-(3,5-di-tert-butyl-4-hydroxybenzyl)malonate (CAS #63843-89-0); bis(1-octyloxy-2,2,6,6-tetramethyl-4-piperidyl) sebacate (CAS #129757-67-1); poly[[6-[(1,1,3,3-tetramethylbutyl)amino]-s-triazine-2,4-diyl]-[(2,2,6,6-tetramethyl-4-piperidypimino]-hexamethylene-[(2,2,6,6-tetramethyl-4-piperidypimino] (CAS #71878-19-8); 1,3,5-Triazine-2,4,6-triamine, N,N′″-1,2-ethanediylbis[N-[3-[[4,6-bis[butyl(1,2,2,6,6-pentamethyl-4-piperidinyl)amino]-1,3,5-triazin-2-yl]amino]propyl]-N′,N″-dibutyl-N′,N″-bis(1,2,2,6,6-pentamethyl-4-piperidinyl)- (CAS #106990-43-6); 1,6-Hexanediamine, N,N′-bis(2,2,6,6-tetramethyl-4-piperidinyl)-, polymer with 2,4,6-trichloro-1,3,5-triazine, reaction products with, N-butyl-1-butanamine and N-butyl-2,2,6,6-tetramethyl-4-piperidinamine (CAS #192268-64-7). Examples of the HALS are commercially available under the tradenames TINUVIN™ 622 and CHIMASSORB™ 944 from BASF, Ludwigshafen, Germany.

The polymeric composition may comprise from 0.1 wt % to 1.0 wt % of the HALS based on the total weight of the polymeric composition. For example, the polymeric composition may comprise 0.1 wt % or greater, or 0.2 wt % or greater, or 0.3 wt % or greater, or 0.4 wt % or greater, or 0.5 wt % or greater, or 0.6 wt % or greater, or 0.7 wt % or greater, or 0.8 wt % or greater, or 0.9 wt % or greater, while at the same time, 1.0 wt % or less, or 0.9 wt % or less, or 0.8 wt % or less, or 0.7 wt % or less, or 0.6 wt % or less, or 0.5 wt % or less, or 0.4 wt % or less, or 0.3 wt % or less, or 0.2 wt % or less of the HALS based on the total weight of the polymeric composition.

### Metal Oxide and Hydroxide

The polymeric composition comprises at least one of MgO, Mg(OH)₂, ZnO and Zn(OH)₂. As explained above, it has surprisingly been discovered that the incorporation of specific metal oxides and hydroxides are able to effectively neutralize acids present in the polymeric composition which would otherwise neutralize the HALS. Through inclusion of at least one of MgO, Mg(OH)₂, ZnO and Zn(OH)₂, coated conductors are able to achieve a greater retained tensile strength and elongation at break after exposure to ultraviolet radiation by protecting the HALS from deactivation.

The polymeric composition comprises 0.1 wt % to 5.0 wt % of at least one of MgO, Mg(OH)₂, ZnO and Zn(OH)₂ based on the total weight of the polymeric composition. For example, the polymeric composition may comprise 0.1 wt % or greater, or 0.2 wt % or greater, or 0.4 wt % or greater, or 0.6 wt % or greater, or 0.8 wt % or greater, or 1.0 wt % or greater, or 1.2 wt % or greater, or 1.4 wt % or greater, or 1.6 wt % or greater, or 1.8 wt % or greater, or 2.0 wt % or greater, or 2.2 wt % or greater, or 2.4 wt % or greater, or 2.6 wt % or greater, or 2.8 wt % or greater, or 3.0 wt % or greater, or 3.2 wt % or greater, or 3.4 wt % or greater, or 3.6 wt % or greater, or 3.8 wt % or greater, or 4.0 wt % or greater, or 4.2 wt % or greater, or 4.4 wt % or greater, or 4.6 wt % or greater, or 4.8 wt % or greater, while at the same time, 5.0 wt % or less, or 4.8 wt % or less, or 4.6 wt % or less, or 4.4 w % or less, or 4.2 wt % or less, or 4.0 wt % or less, or 3.8 wt % or less, or 3.6 wt % or less, or 3.4 w % or less, or 3.2 wt % or less, or 3.0 wt % or less, or 2.8 wt % or less, or 2.6 wt % or less, or 2.4 w % or less, or 2.2 wt % or less, or 2.0 wt % or less, or 1.8 wt % or less, or 1.6 wt % or less, or 1.4 w % or less, or 1.2 wt % or less, or 1.0 wt % or less, or 0.8 wt % or less, or 0.6 wt % or less, or 0.4 w % or less, or 0.2 wt % or less of at least one of MgO, Mg(OH)₂, ZnO and Zn(OH)₂ based on the total weight of the polymeric composition. The polymeric composition may comprise from 0.1 wt % to 3 wt % of at least one of ZnO and Zn(OH)₂. The polymeric composition may comprise from 0.5 wt % to 2 wt % of at least one of MgO and Mg(OH)₂ based on the total weight of the polymeric composition. The polymeric composition may comprise from 1.4 wt % to 1.8 wt % of at least one of MgO and Mg(OH)₂ based on the total weight of the polymeric composition.

### Additives

The polymeric composition may comprise additional additives in the form of antioxidants, cross-linking co-agents, cure boosters and scorch retardants, processing aids, coupling agents, ultraviolet stabilizers (including UV absorbers such as hydroxyphenyl triazine), antistatic agents, additional nucleating agents, slip agents, lubricants, viscosity control agents, tackifiers, anti-blocking agents, surfactants, extender oils, acid scavengers, flame retardants and metal deactivators. The polymeric composition may comprise from 0.01 wt % to 10 wt % of one or more of the additional additives.

The polymeric composition may be free of carbon black. As used herein, the term “free of” is defined to mean that the formulation comprises less than 0.5 wt % of carbon black based on a total weight of the polymeric composition. As highlighted above, carbon black is effective in absorbing ultraviolet light and preventing free radical generation but has a strong effect on the ability to impart a desired color to the polymeric composition. The inclusion of at least one of MgO, Mg(OH)₂, ZnO and Zn(OH)₂ prolongs the useful life of the HALS such that carbon black is not needed and therefore can be eliminated from the polymeric composition.

The polymeric composition may comprise a colorant. As explained above, the absence of carbon black allows the polymeric composition to be colorable by a colorant. The colorant may comprise one or more of an azo dye, an anthraquinone dye and phthalocyanines. The polymeric composition may comprise one or more COLOUR INDEX™ generic name colorants such as Pigment Violet 32 (CAS #12225-08-0), Pigment Orange 34 (CAS #15793-73-4), Pigment Red 38 (CAS #6358-87-8), Pigment Red 208 (CAS #31778-10-6), Pigment Red 48:2 (CAS #7023-61-2), Pigment Red 57:1 (CAS #5281-04-9), Pigment Yellow 155 (CAS #68516-73-4/77465-46-4), Pigment Yellow 151 (CAS #31837-42-0), Pigment Green 7 (CAS #1328-53-6), Pigment Red 122 (CAS #980-26-7/16043-40-6), Pigment Red 214 (CAS #40618-31-3), Pigment Violet 23 (CAS #6358-30-1), and/or Pigment Yellow 191 (CAS #129423-54-7).

The polymeric composition can include one or more particulate fillers, such as glass fibers or various mineral fillers including nano-composites. Fillers, especially those with elongated or platelet-shaped particles providing a higher aspect ratio (length/thickness), may improve modulus and post-extrusion shrinkage characteristics. The filler(s) can have a median size or d50 of less than 20 μm, less than 10 μm, or less than 5 μm. The fillers may be surface treated to facilitate wetting or dispersion in the polymeric composition. Specific examples of suitable fillers include, but are not limited to, calcium carbonate, silica, quartz, fused quartz, talc, mica, clay, kaolin, wollastonite, feldspar, aluminum hydroxide, and graphite. Fillers may be included in the polymeric composition in an amount ranging from 2 to 30 wt %, or from 5 to 30 wt % based on the total weight of the polymeric composition.

The processing aids may comprise metal salts of fluororesin such as polytetrafluoroethylene or Fluorinated ethylene propylene; carboxylic acids such as zinc stearate or calcium stearate; fatty acids such as stearic acid, oleic acid, or erucic acid; fatty amides such as stearamide, oleamide, erucamide, or N,N′-ethylene bis-stearamide; polyethylene wax; oxidized polyethylene wax; polymers of ethylene oxide; copolymers of ethylene oxide and propylene oxide; vegetable waxes; petroleum waxes; non-ionic surfactants; silicone fluids and polysiloxanes.

The antioxidants may comprise hindered phenols such as tetrakis[methylene(3,5-di-tert-butyl-4-hydroxyhydro-cinnamate)]methane; bis[(beta-(3,5-ditert-butyl-4-hydroxybenzyl) methyl carboxyethyl)]-sulphide, 4,4′-thiobis(2-methyl-6-tert-butylphenol), 4,4′-thiobis(2-tert-butyl-5-methylphenol), 2,2′-thiobis(4-methyl-6-tert-butylphenol), and thiodiethylene bis(3,5-di-tert-butyl-4-hydroxy)-hydrocinnamate; phosphites and phosphonites such as tris(2,4-di-tert-butylphenyl)phosphite and di-tert-butylphenyl-phosphonite; thio compounds such as dilaurylthiodipropionate, dimyristylthiodipropionate, and distearylthiodipropionate; various siloxanes; polymerized 2,2,4-trimethyl-1,2-dihydroquinoline, n,n′-bis(1,4-dimethylpentyl-p-phenylenediamine), alkylated diphenylamines, 4,4′-bis(alpha, alpha-dimethylbenzyl)diphenylamine, diphenyl-p-phenylenediamine, mixed di-aryl-p-phenylenediamines, and other hindered amine anti-degradants or stabilizers.

### Compounding

The components of the polymeric composition can be added to a batch or continuous mixer for melt blending. The components can be added in any order or first preparing one or more masterbatches for blending with the other components. The melt blending may be conducted at a temperature above the highest melting polymer. The melt-blended composition can then either be delivered to an extruder or an injection-molding machine or passed through a die for shaping into the desired article, or converted to pellets, tape, strip or film or some other form for storage or to prepare the material for feeding to a next shaping or processing step. Optionally, if shaped into pellets or some similar configuration, then the pellets, etc. can be coated with an anti-block agent to facilitate handling while in storage.

Examples of compounding equipment that may be used include internal batch mixers, continuous single or twin-screw mixers, or kneading continuous extruders. The type of mixer utilized, and the operating conditions of the mixer, will affect properties of the composition such as viscosity, volume resistivity, and extruded surface smoothness.

### Mechanical Properties

The polymeric composition may exhibit a non-UV aged or UV aged maximum tensile strength of 20.0 mega pascals (MPa) to 35.0 MPa as measured according to ASTM D638. For example the polymeric composition may exhibit a maximum tensile strength of 20.0 MPa or greater, or 20.5 MPa or greater, or 21.0 MPa or greater, or 21.5 MPa or greater, or 22.0 MPa or greater, or 22.5 MPa or greater, or 23.0 MPa or greater, or 23.5 MPa or greater, or 24.0 MPa or greater, or 24.5 MPa or greater, or 25.0 MPa or greater, or 25.5 MPa or greater, or 26.0 MPa or greater, or 26.5 MPa or greater, or 27.0 MPa or greater, or 27.5 MPa or greater, or 28.0 MPa or greater, or 28.5 MPa or greater, or 29.0 MPa or greater, or 29.5 MPa or greater, or 30.0 MPa or greater, or 30.5 MPa or greater, or 31.0 MPa or greater, or 31.5 MPa or greater, or 32.0 MPa or greater, or 32.5 MPa or greater, or 33.0 MPa or greater, or 33.5 MPa or greater, or 34.0 MPa or greater, or 34.5 MPa or greater, while at the same time, 35.0 MPa or less, or 34.5 MPa or less, or 34.0 MPa or less, or 33.5 MPa or less, or 33.0 MPa or less, or 32.5 MPa or less, or 32.0 MPa or less, or 31.5 MPa or less, or 31.0 MPa or less, or 30.5 MPa or less, or 30.0 MPa or less, or 29.5 MPa or less, or 29.0 MPa or less, or 28.5 MPa or less, or 28.0 MPa or less, or 27.5 MPa or less, or 27.0 MPa or less, or 26.5 MPa or less, or 26.0 MPa or less, or 25.5 MPa or less, or 25.0 MPa or less, or 24.5 MPa or less, or 24.0 MPa or less, or 23.5 MPa or less, or 23.0 MPa or less, or 22.5 MPa or less, or 22.0 MPa or less, or 21.5 MPa or less, or 21.0 MPa or less, or 20.5 MPa or less.

The polymeric composition may exhibit a non-UV aged or UV aged elongation at break of 550% to 1000% as measured according to ASTM D638. For example the polymeric composition may exhibit an elongation at break of 550% or greater, or 560% or greater, or 570% or greater, or 580% or greater, or 590% or greater, or 600% or greater, or 610% or greater, or 620% or greater, or 630% or greater, or 640% or greater, or 650% or greater, or 660% or greater, or 670% or greater, or 680% or greater, or 690% or greater, or 700% or greater, or 710% or greater, or 720% or greater, or 730% or greater, or 740% or greater, or 750% or greater, or 760% or greater, or 770% or greater, or 780% or greater, or 790% or greater, or 800% or greater, or 810% or greater, or 820% or greater, or 830% or greater, or 840% or greater, or 850% or greater, or 860% or greater, or 870% or greater, or 880% or greater, or 890% or greater, or 900% or greater, or 910% or greater, or 920% or greater, or 930% or greater, or 940% or greater, or 950% or greater, or 960% or greater, or 970% or greater, or 980% or greater, or 990% or greater, while at the same time, 1000% or less, or 990% or less, or 980% or less, or 970% or less, or 960% or less, or 950% or less, or 940% or less, or 930% or less, or 920% or less, or 910% or less, or 900% or less, or 890% or less, or 880% or less, or 870% or less, or 860% or less, or 850% or less, or 840% or less, or 830% or less, or 820% or less, or 810% or less, or 800% or less, or 790% or less, or 780% or less, or 770% or less, or 760% or less, or 750% or less, or 740% or less, or 730% or less, or 720% or less, or 710% or less, or 700% or less, or 690% or less, or 680% or less, or 670% or less, or 660% or less, or 650% or less, or 640% or less, or 630% or less, or 620% or less, or 610% or less, or 600% or less, or 590% or less, or 580% or less, or 570% or less, or 560% or less.

The polymeric composition may have a retained maximum tensile strength and/or a retained elongation at break (both measured by dividing the UV aged value by the non-UV aged value) of 65% or greater, or 70% or greater, or 75% or greater, or 80% or greater, or 85% or greater, or 90% or greater, or 95% or greater, while at the same time, 100% or less, or 95% or less, or 90% or less, or 85% or less, or 80% or less, or 75% or less, or 70% or less.

### Coated Conductor

The present disclosure also provides a coated conductor. The coated conductor includes a conductor and a coating on the conductor, the coating including the polymeric composition. The polymeric composition is at least partially disposed around the conductor to produce the coated conductor. The conductor may comprise a conductive metal or an optically transparent structure.

The process for producing a coated conductor includes mixing and heating the polymeric composition to at least the melting temperature of the polymeric components in an extruder to form a polymeric melt blend, and then coating the polymeric melt blend onto the conductor. The term “onto” includes direct contact or indirect contact between the polymeric melt blend and the conductor. The polymeric melt blend is in an extrudable state.

The polymeric composition is disposed around on and/or around the conductor to form a coating. The coating may be one or more inner layers such as an insulating layer. The coating may wholly or partially cover or otherwise surround or encase the conductor. The coating may be the sole component surrounding the conductor. Alternatively, the coating may be one layer of a multilayer jacket or sheath encasing the conductor. The coating may directly contact the conductor. The coating may directly contact an insulation layer surrounding the conductor.

### EXAMPLES

### Materials

The following materials are employed in the Examples, below.

HDPE is a high-density polyethylene (HDPE) comprised of an ethylene/octene copolymer and having a density of 0.9450 g/cc and a melt index of 0.80 g/10 min, which is available from The Dow Chemical Company, Midland, Mich., USA.

LLDPE is a linear low-density polyethylene having a density of 0.920 g/cc, a melt flow index of 0.55 to 0.75 g/10 min. and is available from The Dow Chemical Company, Midland, Mich., USA.

AO is a sterically hindered phenolic antioxidant having the chemical name pentaerythritol tetrakis(3-(3,5-di-tert-butyl-4-hydroxyphenyl)propionate), and is commercially available as IRGANOX 1010™ from BASF, Ludwigshafen, Germany.

UVA is an ultraviolet light absorber with the chemical composition hydloxyphenyl triazine and commercially available as TINUVIN™ 1577 from BASF, Ludwigshafen, Germany.

HALS1 is a hindered amine light stabilizer (CAS #70624-18-9) having the chemical name poly[[6-[(1,1,3,3-tetramethylbutyl)amino]-1,3,5-triazine-2,4-diyl][(2,2,6,6-tetramethyl-4-piperidinyl)imino]-1,6 hexanediyl[(2,2,6,6-tetramethyl-4-piperidinyl)imino]]), and is commercially available as CHIMASSORB™ 944 from BASF, Ludwigshafen, Germany.

HALS2 is an oligomeric hindered amine light stabilizer having the chemical composition of poly(4-hydroxy-2,2,6,6-tetramethyl-1-piperidineethanol-alt-1,4-butanedioic acid) (CAS #65447-77-0) and is commercially available as TINUVIN™ 622 from BASF, Ludwigshafen, Germany.

MgO is magnesium oxide commercially available from Lanxess corporation, Pittsburgh, Pa., USA.

ZnO is zinc oxide commercially available from Sinopharm Chemical Reagent Co. Ltd., China.

### Sample Preparation

Samples were prepared by compounding the HDPE and the LDPE in a BRABENDER™ mixer at 150° C. The rotor speed of the mixer was set to 30 revolutions per minute (“RPM”). The components other than the HDPE and LDPE were fed into the mixer. The rotor speed was increased to 80 RPM and the samples were mixed for an additional 5 minutes. The samples were then cooled and cut into small pieces.

40 grams of the small pieces were sandwiched between two biaxially-oriented polyethylene terephthalate (i.e., Mylar) sheets and put into a mold with size of 100 millimeters (“mm”)×200 mm×2 mm. The mold was placed in a KT-201-A hot press machine from Shanghai Great Instrument Co. Ltd and preheated at 170° C. for 10 minutes. The mold was vented 8 times. Then the mold was held at 170° C. and 10 mega pascals (“MPa”) as measured by the hot press machine for another 5 minutes. Next the mold was cooled to room temperature using internal water cooling within 5 minutes at 10 MPa to form plaques.

The plaques were cut into 5A dogbones according to ISO 527-2. The 5A dogbones were placed in a SUV-W161 super ultraviolet (“UV”) solar simulation weathering chamber from EYE Applied Optix to conduct super UV (“SUV”) aging. The exposure cycle consisted of a light cycle of 1 hour followed by a dark period of 2 hours with continuous water spray on the front surface. In the light cycle, the broadband irradiance, an integral of spectral irradiance from 295 nm to 400 nm, was controlled at 1500 W/m². The uninsulated black panel temperature (“BPT”) was 70±3 degree C. with the light on and 55±3 degree C. with light off. The relative humidity was 70±10% during the light cycle and greater than 95% during the dark cycle. The air temperature was uncontrolled during the entire operation. Samples, each with at least four replicates, were aged for 4 weeks (a total of 1200 MJ/m²) or 8 weeks (total of 2400 MJ/m²). The 1200 MJ/m² broadband UV dosage is equivalent to 5700 hours Xenon-Arc aging/10,000 hours fluorescent aging described under ASTM D1248, or 7600 hours Xenon-Arc aging described under IEC 60794.

### Test Methods

Tensile strength maximum and tensile elongation at break of the samples was performed in accordance with ASTM D638 on an 5565 tensile testing machine from Instron Calibration Lab.

Table 1 provides the relevant standards for UV testing that the samples are compared against.

TABLE 1

| | ASTM D1248 | | IEC 60794 |
|---|---|---|---|
| UV Lamp Type | Xenon-Arc | Fluorescent | Xenon-Arc |
| UV Dosage | 5.12 | 2.76 | 3.8 |
| Output (MJ/m² | | | |
| per 24 hours) | | | |
| Testing | 4000 hours | 4000 hours | 4000 hours |
| Duration | | | |
| Total UV | 853 | 460 | 633 |
| dosage after | | | |
| 4000 Hours | | | |
| (MJ/m²) | | | |
| Mechanical | Tensile | Tensile | Tensile |
| testing | elongation | elongation | elongation |
| requirement | Retention >50% | Retention >50% | Retention >80% |

### Results

Table 2 provides the composition (“Comp.”) as well as mechanical properties such as maximum tensile strength (“TS Max”), the tensile elongation at break (“TE”), max tensile strength retention (“TS Retention”) and tensile elongation at break retention (“TE Retention”) for inventive examples (“IE”) 1-12 for different periods of accelerated UV aging.

TABLE 2

| Comp. | Component | IE-1 | IE-2 | IE-3 | IE-4 | IE-5 | IE-6 | IE-7 | IE-8 | IE-9 | IE-10 | IE-11 | IE-12 |
|---|---|---|---|---|---|---|---|---|---|---|---|---|---|
| | HDPE | 86.83 | 86.48 | 85.77 | 84.54 | 86.83 | 86.48 | 86.12 | 85.77 | 85.42 | 84.98 | 84.54 | 83.66 |
| | LLDPE | 11.77 | 11.72 | 11.63 | 11.46 | 11.77 | 11.72 | 11.68 | 11.63 | 11.58 | 11.52 | 11.46 | 11.34 |
| | AO | 0.20 | 0.20 | 0.20 | 0.20 | 0.20 | 0.2 | 0.20 | 0.20 | 0.20 | 0.20 | 0.20 | 0.20 |
| | UVA | 0.20 | 0.20 | 0.20 | 0.20 | 0.20 | 0.2 | 0.20 | 0.20 | 0.20 | 0.20 | 0.20 | 0.20 |
| | HALS1 | 0.30 | 0.30 | 0.30 | 0.30 | 0.30 | 0.3 | 0.30 | 0.30 | 0.30 | 0.30 | 0.30 | 0.30 |
| | HALS2 | 0.30 | 0.30 | 0.30 | 0.30 | 0.30 | 0.3 | 0.30 | 0.30 | 0.30 | 0.30 | 0.30 | 0.30 |
| | MgO | 0 | 0 | 0 | 0 | 0.4 | 0.8 | 1.20 | 1.60 | 2.00 | 2.50 | 3.00 | 4.00 |
| | ZnO | 0.40 | 0.80 | 1.60 | 3.00 | 0 | 0 | 0 | 0 | 0 | 0 | 0 | 0 |
| | Total | 100.00 | 100.00 | 100.00 | 100.00 | 100.00 | 100.00 | 100.00 | 100.00 | 100.00 | 100.00 | 100.00 | 100.00 |
| Initial | TS max | 25.9 | 28.4 | 30.2 | 29.3 | 26.8 | 33.6 | 27.4 | 28.8 | 25.9 | 27.5 | 28.7 | 26.4 |
| Properties | (MPa) | | | | | | | | | | | | |
| | TE (%) | 762 | 864 | 1019 | 1028 | 755 | 988 | 857 | 924 | 822 | 892 | 913 | 874 |
| 4 Weeks | TS max | 26.9 | 24.7 | 27.2 | 27.7 | 27.6 | 25.2 | N/A | 28.6 | N/A | N/A | 27.5 | N/A |
| SUV | (MPa) | | | | | | | | | | | | |
| Aging | TE (%) | 824 | 663 | 989 | 766 | 884 | 682 | N/A | 855 | N/A | N/A | 727 | N/A |
| (1200 | TS Retention | 103.8 | 86.8 | 90.2 | 94.6 | 103.0 | 74.9 | N/A | 99.3 | N/A | N/A | 95.5 | N/A |
| MJ/m²) | (%) | | | | | | | | | | | | |
| | TE Retention | 108.1 | 76.7 | 97.1 | 74.5 | 117.0 | 69.1 | N/A | 92.5 | N/A | N/A | 79.7 | N/A |
| | (%) | | | | | | | | | | | | |
| 8 Weeks | TS Max | 24.5 | 24.2 | 24.4 | 24.5 | 23.9 | 23.9 | 20.7 | 25.1 | 20.5 | 20.7 | 24.6 | 20.5 |
| SUV | (MPa) | | | | | | | | | | | | |
| Aging | TE (%) | 243 | 125 | 84 | 68 | 457 | 423 | 641 | 758 | 559 | 506 | 578 | 563 |
| (2400 | TS Retention | 94.4 | 85.2 | 80.8 | 83.6 | 89.4 | 71.0 | 75.6 | 87.1 | 78.9 | 75.4 | 85.5 | 77.7 |
| MJ/m²) | (%) | | | | | | | | | | | | |
| | TE Retention | 31.9 | 14.4 | 8.3 | 6.6 | 60.5 | 42.8 | 74.7 | 82.0 | 68.1 | 56.7 | 63.3 | 64.4 |
| | (%) | | | | | | | | | | | | |

With respect to 4 weeks of aging in Table 2, IE1-IE12 exhibits a TS Retention and TE Retention of greater than 50% for 4 weeks (1200 MJ/m²) of SUV aging indicating that ZnO, MgO, Zn(OH)₂ and Mg(OH)₂ (the hydroxides are believed to have formed in the polymeric composition due to moisture) are effective in allowing the polymeric composition to pass ASTM D1248 aging despite being free of carbon black. It should be noted that the total quantity of UV energy IE1-IE12 were exposed to (1200 MJ/m²) is well in excess of the requirements of ASTM D1248 (853 MJ/m²). IE1, IE3, IE5 and IE8 are all able to pass the 80% TE retention requirement of IEC 60794 despite receiving nearly double the UV exposure stipulated by IEC 60794 (633 MJ/m²). In view of the results, it is believed that IE1-IE12 would all pass ASTM D1248 and IEC 60794.

With respect to the 8 weeks of aging in Table 2, it was surprisingly discovered that IE5 and IE7-IE12 were all able to pass the 50% or greater TE retention requirement of ASTM D1248 despite receiving nearly three times the UV energy as stipulated by ASTM D1248. Even more surprising is that IE8 was able to meet the 80% or greater TE retention requirement of IEC 60794 despite receiving nearly four times the UV energy as stipulated by IEC 60794. These results indicate that MgO and Mg(OH)₂ generate surprising results from 1.00 wt % to 2.00 wt %, and more specifically from 1.4 wt % to 1.8 wt % where the polymeric composition can retain greater than 80% tensile elongation after 2400 MJ/m2 of UV exposure despite being free of carbon black.

1. A polymeric composition, comprising:
90 wt % to 99 wt % of an ethylene-based polymer based on a total weight of the polymeric composition;
0.1 wt % to 1 wt % of a hindered amine light stabilizer based on the total weight of the polymeric composition; and
0.1 wt % to 5.0 wt % of at least one of MgO, Mg(OH)₂, ZnO and Zn(OH)₂ based on the total weight of the polymeric composition.

2. The polymeric composition of claim 1, wherein the polymeric composition is free of carbon black.

3. The polymeric composition of claim 2, further comprising
a colorant.

4. The polymeric composition of claim 1, wherein the ethylene-based polymer comprises a low-density polyethylene having a density of 0.917 g/cc to 0.926 g/cc as measured according to ASTM D792 and a high-density polyethylene having a density of 0.940 g/cc to 0.970 g/cc as measured according to ASTM D792.

5. The polymeric composition of claim 4, wherein the polymeric composition comprises 80 wt % to 95 wt % high-density polyethylene based on the total weight of the polymeric composition.

6. The polymeric composition of claim 5, wherein the polymeric composition comprises 5 wt % to 20 wt % of the low-density polyethylene based on the total weight of the polymeric composition.

7. The polymeric composition of claim 1, wherein the polymeric composition comprises from 0.1 wt % to 3 wt % of at least one of ZnO and Zn(OH)₂.

8. The polymeric composition of claim 1, wherein the polymeric composition comprises from 1.0 wt % to 2 wt % of at least one of MgO and Mg(OH)₂ based on the total weight of the polymeric composition.

9. The polymeric composition of claim 8, wherein from 1.4 wt % to 1.8 wt % of the polymeric composition is MgO and Mg(OH)₂ based on the total weight of the polymeric composition.

10. A coated conductor comprising:
a conductor; and
the polymeric composition of claim 1 disposed at least partially around the conductor.
